(19) United States
(12) Patent Application Publication
(10) Pub. No.: US 2023/0281212 A1
(43) Pub. Date: Sep. 7, 2023

(54) GENERATING SMART AUTOMATED DATA MOVEMENT WORKFLOWS

(71) Applicant: International Business Machines Corporation, Armonk, NY (US)

(72) Inventors: Anton Zorin, Waedenswil (CH); Manish Kesarwani, Bengaluru (IN); Niels Dominic Pardon, Zurich (CH); Ritesh Kumar Gupta, Hyderabad (IN); Sameep Mehta, Bangalore (IN)

(21) Appl. No.: 17/653,700

(22) Filed: Mar. 7, 2022

(51) Int. Cl. G06F 16/25; G06F 16/21; G06N 5/04

(52) U.S. Cl. CPC G06F 16/254; G06F 16/213; G06N 5/04

(57) ABSTRACT

A computer-implemented method generates an automated data movement workflow. The method includes transforming a received request for data, which was received in a restricted natural language form, into a form suitable for accessing a metadata repository. The method further includes identifying data and data dependencies using the transformed request for data. The method further includes building a workflow using the identified data and data dependencies. The method further includes, upon applying at least one governance rule to the workflow, modifying the built workflow to be compliant with the at least one governance rule, and if no compliance with the at least one governance rule is achievable, recommending a change to the built workflow.

### BACKGROUND

The present disclosure relates generally to computer systems, and more specifically, to a computer-implemented method for generating an automated data movement workflow. The present disclosure relates further to a recommender and generator system for generating an automated data movement workflow, and a computer program product.

### SUMMARY

Embodiments of the present disclosure include a computer-implemented method for generating an automated data movement workflow. The method includes transforming a received request for data, which was received in a restricted natural language form, into a form suitable for accessing a metadata repository. The method further includes identifying data and data dependencies using the transformed request for data. The method further includes building a workflow using the identified data and data dependencies. The method further includes, upon applying at least one governance rule to the workflow, modifying the built workflow to be compliant with the at least one governance rule, and if no compliance with the at least one governance rule is achievable, recommending a change to the built workflow.

Additional embodiments of the present disclosure include a recommender and generator system for generating an automated data movement workflow. The system includes a processor and a memory, communicatively coupled to the processor. The memory stores program code portions that, when executed, enable the processor to perform a method. The method includes transforming a received request for data, which was received in a restricted natural language form, into a form suitable for accessing a metadata repository. The method further includes identifying data and data dependencies using the transformed request for data. The method further includes building a workflow using the identified data and data dependencies. The method further includes, upon applying at least one governance rule to the workflow, modifying the built workflow to be compliant with the at least one governance rule, and if no compliance with the at least one governance rule is achievable, recommending a change to the built workflow.

Additional embodiments of the present disclosure include a computer program product for generating an automated data movement workflow. The computer program product includes a computer readable storage medium having program instructions embodied therewith. The program instructions are executable by one or more computing systems or controllers to cause the one or more computing systems to perform a method. The method includes transforming a received request for data, which was received in a restricted natural language form, into a form suitable for accessing a metadata repository. The method further includes identifying data and data dependencies using the transformed request for data. The method further includes building a workflow using the identified data and data dependencies. The method further includes, upon applying at least one governance rule to the workflow, modifying the built workflow to be compliant with the at least one governance rule, and if no compliance with the at least one governance rule is achievable, recommending a change to the built workflow.

It should be noted that embodiments of the present disclosure are described with reference to different subject-matters. In particular, some embodiments are described with reference to method type claims, whereas other embodiments are described with reference to apparatus type claims. However, a person skilled in the art will gather from the disclosure that, unless otherwise notified, in addition to any combination of features belonging to one type of subject matter, also any combination of features relating to different subject matters, such as features of the method type claims and features of the apparatus type claims, is considered as to be disclosed within this document.

The aspects defined above and further aspects of the present disclosure are apparent from the examples of embodiments described hereinafter and are explained with reference to the examples of embodiments, to which the disclosure is not limited.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 shows a block diagram of an example embodiment of a computer-implemented method for generating an automated data movement workflow, in accordance with embodiments of the present disclosure.

FIG. 2 shows a block diagram of an example embodiment of an ETL pipeline, for example, in a cloud environment, in accordance with embodiments of the present disclosure.

FIG. 3 shows a block diagram of an example embodiment of a smart data movement advisor and designer user interface, in accordance with embodiments of the present disclosure.

FIG. 4 shows a block diagram of a flow diagram of an example embodiment of a smart data movement system, in accordance with embodiments of the present disclosure.

FIG. 5 shows a block diagram of a sample smart data movement flow/workflow, in accordance with embodiments of the present disclosure.

FIG. 6 shows an example embodiment of a technical architecture of the smart data discovery system for generating workflows, in accordance with embodiments of the present disclosure.

FIG. 7 shows an example embodiment of a clearance level tree for data access rights, in accordance with embodiments of the present disclosure.

FIG. 8 shows a block diagram of an example recommender and generator system for generating an automated data movement workflow, in accordance with embodiments of the present disclosure.

FIG. 9 shows a block diagram of an example computing system including the recommender and generator system according to FIG. 8, in accordance with embodiments of the present disclosure.

### DETAILED DESCRIPTION

In the context of this description, the following conventions, terms and/or expressions may be used:

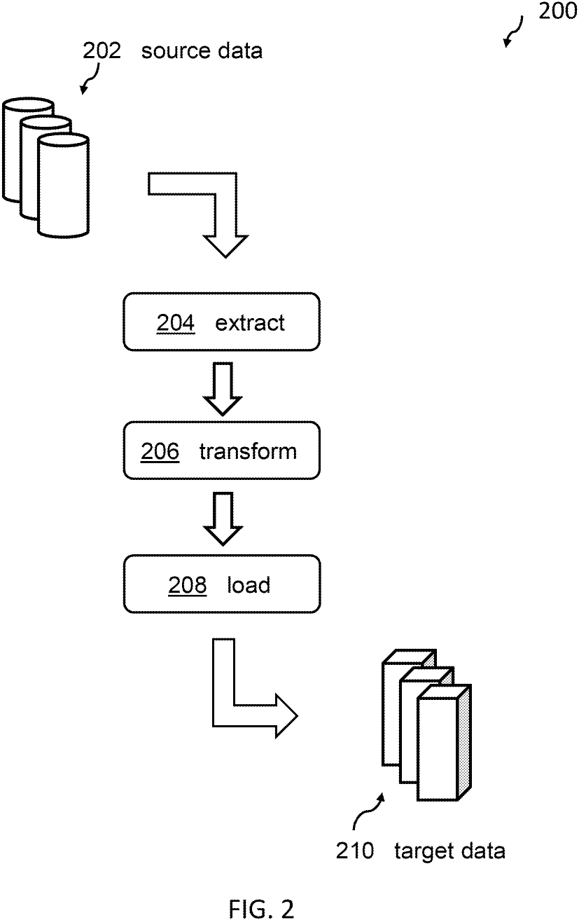

The term “data movement workflow” may be used to basically refer to movement of data through a system. For example, an extraction, a transformation, and a loading of data to a target location, known as ETL workflow, is one type of data movement workflow. As discussed in further detail below, FIG. 2 illustrates an example ETL workflow. Certain restrictions must be reflected when performing such an ETL workflow. As an example, if only a simple copy process is intended, a null transformation (also referred to as no action or no transformation) would be involved. In contrast, during the transformation, data enrichment activities of a determination of intermediate results of mathematical functions may also be included.

The term “data discovery” as used herein may refer to instances in which it is not clear from the outset which data are available and which data may be used for a certain ETL workflow. Hence, data must be analyzed and searched for before using as source data. Such processes may be referred to as “data discovery.” Once the data are prepared, a user may discover new dependencies and gain new insights from the requested data.

The term “restricted natural language form” as used herein may refer to an expression in a constrained natural language, for example, in a human understandable syntax. This form of input or source for defining an ETL workflow does not force the human user to learn restrictive data selection programming-styles, such as expressions. Only one type of data source and one type of transformation, as mentioned, may be required. A simple example would be: “show me all employees hired before January 1^{st}, 2020.”

The term “metadata repository” as used herein may refer to a storage location comprising data about available sources, target data, and its respective data format. Data about data replications may also be available in the metadata repository. Metadata are basically data about other data, for example, the source data and the target data.

The term “data dependency” as used herein may relate to true dependencies between data. A second data set may depend on a first data set. In such instances, the second data set may be referred to as being at a lower level of a dependency tree. Hence, accessing only the second (lower level) data without the context of the first data set may not provide the sought insight. In other words, the second data set may be meaningless without the context of the first data set.

The term “workflow” as used herein may refer to a predefined set of activities performed on or with data. For example, in an ETL workflow, data may be fetched, transformed, and loaded to a target location.

The term “governance rule” as used herein may refer to technical, organizational, or legal constraints regarding how certain data is to be treated. Privacy regulations as well as data access laws are common examples. In general, governance rules, as well as clearance levels of users, fall under the general regulation of data access rights.

The term “clearance level” as used herein may refer to a classification of data to determine which data a user may and may not have access to.

The term “requestor identifier value” as used herein may refer to an identifier of a user who is requesting certain data. The requestor identifier value may be an alpha-numerical value.

Turning now to an overview of technologies that are more specifically relevant to aspects of the present disclosure, in times when data and information drive new process and business models, successful data management and data discovery remains at the top of the priority list of information technology (IT) management. In the past few years, companies have accumulated large amounts of additional data — often quite unstructured through data lakes — so it is sometimes difficult to find data related to business success issues. The role of data warehouses is still to be a pillar of success for successful data management and the provision of data for a large number of users and companies.

However, the traditional data movement pipeline model — commonly referred to as ETL (extract-transform-load) — has reached its limits due to at least the following three factors: (i) not all data are available in an enterprise data warehouse; (ii) many relevant data are not structured data; and (iii) not all required data are managed within a company, but are also in external or hybrid cloud storage systems. Therefore, the data may be spread across multiple clouds and locations. Additionally, different cloud systems may be managed with their own data governance and policy constraints. Moreover, users may often be unaware of the data that could be in various sources. As a consequence, data extraction, transformation, and load activities are becoming increasingly complex and very often manual tasks. Because of multiple copies (replicas) of data and the distribution across multiple geographies (each of which may have its own legal data access systems), a regular business user may be overwhelmed by the activities required to find the data to answer decision supporting questions: namely, identifying the correct data, using the nearest data replica, finding a valid location to perform transformations (including a definition of the various stages of the transformation), confirming a transformation cost correctness, ensuring compliance, caring about runtime optimization activities, and so on. Furthermore, this “data territory” may also be constantly evolving.

In light of data discovery self-service projects, enterprise IT management is constantly looking for smarter solutions to enable end-users to find their way to “their searched data” in a constantly evolving data landscape.

Hence, there is a need to overcome the mostly manual process that requires a lot of knowledge and experience in the business context, data management, technology, and compliance questions. To tackle this complex problem, enterprises might also use multiple different technologies (for example, DataStage, SQL, Jupyter) to implement data movement related tasks. This may often lead to mistakes and inefficiencies due to a lack of knowledge, a lack of experience, or the complexity of using multiple technology in a data flow. These inefficiencies occur often throughout the whole information management lifecycle from creation, operation, conflict avoidance, and compliance assurance within the information landscape (systems, applications, data, access, transformations, etc.). Additionally, while constructing data movement workflows is perceived as a static task encapsulating only built time optimizations, in general, the data movement flows could evolve over time due to the dynamic nature of the technical and business environment.

Consequently, it is desirable to provide a method and/or system capable of generating useful recommendations and, additionally, automating different aspects of the data movement pipeline that existing solutions do not provide. Such a method and/or system may include the following components: smart data discovery, analysis of data redundancy across existing flows, identification of data dependencies, compliance and consistency enforcement, automatic workflow generation, workflow binding, runtime optimization of the workflows, deduction of result properties from compliance, access right perspectives, and a re-optimization and evolution of workflows over time. All of these aspects should make novice users, as well as experienced users, more productive and enable them to easily prepare and execute different and scalable data movement flows/workflows.

Embodiments of the present disclosure include a computer-implemented method for generating an automated data movement workflow, which may offer multiple advantages, technical effects, contributions and/or improvements.

For example, the method disclosed herein may enable a higher degree of data access self-service without the requirement of advanced users to define data access workflows for the ever-changing data access requests of users. Hence, data analytics may be used more widely and may enable organizations to make better technical and business decisions on lower organizational levels of the enterprise.

Put another way, an inexperienced user may query data in a very natural form, for example using an expression or a restricted or constrained natural language form. The system may do the rest. This may include a selection of the data searched. Thereby, the system may use various data sources and determination inputs. The system may access the data of the correct transformation and also determine a target location for the transformed data. This may be a storage location, or the data may only be output to a user terminal.

More specifically, embodiments of the present disclosure may also enable defining technical parameters of the underlying technical infrastructure in order to process/execute the workflow. This may include, for example, selecting storage systems, network routes and used computing resources (such as number of CPUs and/or cores, amount of main memory, bandwidth, etc.). Furthermore, collected statistical values about the execution of the workflow and the satisfaction of the user with delivered data may be used to optimize the different phases of the ETL workflow for further queries.

However, advantages enabled by the present disclosure are not limited to instances involving an inexperienced user. Additionally, an experienced user or expert may get a series of recommendations from the system according to the proposed concept which the user may modify in order to generate the data query results. The advanced user may interact at each stage of the ETL workflow such that processing is optimized under the guidance of the experienced user. This may include a modification of transformation rules, used resources as well as access data or applicable user clearance level, as well as applicable governance rules.

Additionally, embodiments of the present disclosure may enable proposing changes to the built workflow, for example if a clearance level of a user from which the request was received is not sufficient to access the data. A plurality of different modifications could be made, such as, proposing a temporary change of the clearance of the user and/or masking column or build aggregations in order not to disclose data the user is not allowed to access.

Therefore, embodiments of the present disclosure may be equally valuable for the novice user as well as for the expert. This may enhance the overall data pipeline in enterprises and empower a completely distributed decision-making process based on facts and not assumptions. This would at least partially be based on the fact that the whole information management process would be sped up. Having the assistance of the system that automates and recommends not only makes information management more accessible to novice and advanced users, but it may also help to speed up the entire process since there would be fewer manual steps and less interactions required between humans. Upon implementation of embodiments of the present disclosure, it is no longer required to find, wait for, and talk to someone who knows where to find what data, knows how to implement a data movement pipeline, etc. Instead, embodiments of the present disclosure facilitate self-service for data becoming a natural process since the role of subj ect-matter experts will be — at least in part — fulfilled by the system.

Additional embodiments and aspects of the present disclosure, which are applicable to the method as well as the system, are described herein.

According to one embodiment of the disclosed method, building the workflow may also include selecting at least one out of a data transformation method (which may also be referred to as a transformation algorithm), an implementation technique, and used infrastructure (which may also be referred to as the underlying technology), for example, a type of a computer (e.g., an architecture), number of cores per CPU, network type, storage type and amount of CPU and the like. The implementation technique may refer to, for example, the programming language or runtime environment used to implement the transformation algorithm, for example, JAVA, Spark, or vendor specific frameworks, like those from Informatica, Datastage, etc.

According to one embodiment of the present disclosure, the method may also include selecting runtime parameter values for executing the built workflow. This may include a number of nodes used, a memory and/or storage size, a degree of parallelism for the computing, and/or similar parameters. Hence, a large variety of operational parameter values may be tuned for optimal results.

According to another embodiment of the present disclosure, the method may also include modifying the selecting runtime parameter values using a user interface. This may be a privilege for an advanced user. In other words, such an enhanced user interface may not be made available to novice users but only to experts. Hence, the method disclosed herein may be useful for advanced as well as for novice users in that the advanced user may have the additional option to modify the system-proposed workflow.

According to another embodiment of the present disclosure, the method may include modifying the identified data and data dependencies before executing the built workflow by receiving a respective instruction — or a plurality thereof — using the aforementioned user interface or a different one. Thus, these parameter values name the source and the sink of the data to be transformed - of the data that may be adjusted manually before going into productive use.

Consequently, and according to a further embodiment of the present disclosure, the method may also include modifying the built workflow before executing it by receiving a respective instruction — or a plurality thereof — using the advanced user interface. Additionally, this feature may be reserved for the experienced user of transformational workflows.

In accordance with some embodiments of the present disclosure, the method may also include determining an expected resource consumption value and/or potential violation of a governance rule. This information may be used by the advanced or experienced user for optimization purposes of the designed workflow. In particular, a violation of governance or data access rules may be interesting for data stewards and/or compliance managers. For example, an alert may be generated if a violation of a governance rule may have happened.

According to another embodiment of the present disclosure, the method may also include collecting and/or storing execution data during an execution of the workflow. Such embodiments advantageously enable the ability to use monitoring and statistical data as feedback for optimization purposes of all elements and or phases of the workflow. Consequently, the method disclosed herein not only enables an automation of a workflow generation for transformative workflows but also a continuous optimization of already existing workflows as well as to-be-generated workflows.

According to another embodiment of the present disclosure, the method may also include: upon receiving a comparable request for data if compared to stored received requests for data, using the collected execution data of the workflow retrieving a stored built workflow. Hence, the effort of building a new workflow is no longer required. In contrast, advanced user modification may already be reflected by this aspect of the disclosed method. The same may apply to runtime parameter values. Because of the usage of NLP (natural language processing), the request does not have to be identical but only similar or likewise. As long as the result of a transformation of the NLP-based request into more strict programming language-like query to data are equal, the already stored workflows may be recycled.

According to a further embodiment of the present disclosure, the method may also include using the collected and stored execution data for an optimization of a subsequent comparable workflow to be built under the constraint that a function value is minimized, wherein the function has a target resource consumption and a response time of the built workflow as variables. Such a resource balancing or resource required for the workflow may be user, time and/or or task specific. For embodiments including or implementing this aspect of the present disclosure, the method may contribute to a good resource usage under load balancing aspects.

According to one embodiment of the disclosed method, the request in the restricted natural language form (such as a request for the automated building of the automated data movement workflow) may include at least a term for a data source and a term for a data transformation. In accordance with at least one embodiment, a transformation target may also be specified. As an illustrative example a natural language request may be: “show me all employees hired after 1.1.2020.” In this example, “all employees” specifies the data source and “hired after 1.1.2020” defines the transformation. The NLP processor is enabled to build — with the help of the metadata repository — a query (for example, in SQL form) to access the data in regular storage systems and construct a filter to select only the requested data. The filter can also be in SQL form.

Embodiments of the present disclosure may be implemented in the form of a related computer program product, accessible from a computer-usable or computer-readable medium providing program code for use by or in connection with a computer or any instruction execution system. For the purpose of this description, a computer-usable or computer-readable medium may be any apparatus that may contain means for storing, communicating, propagating, or transporting the program for use by or in connection with the instruction execution system, apparatus, or device.

According to one aspect of the present disclosure, a computer-implemented method for generating an automated data movement workflow may be provided. The method may include transforming a received request for data, which was received in a restricted natural language form, into a form suitable for accessing a metadata repository, identifying data and data dependencies using the transformed request for data in the form suitable for accessing a metadata repository, and building a workflow using the identified data and data dependencies.

Upon applying at least one governance rule to the workflow, the method may also include modifying the built workflow to be compliant with the at least one governance rule, and if no compliance with the at least one governance rule is achievable, recommending a change to the built workflow.

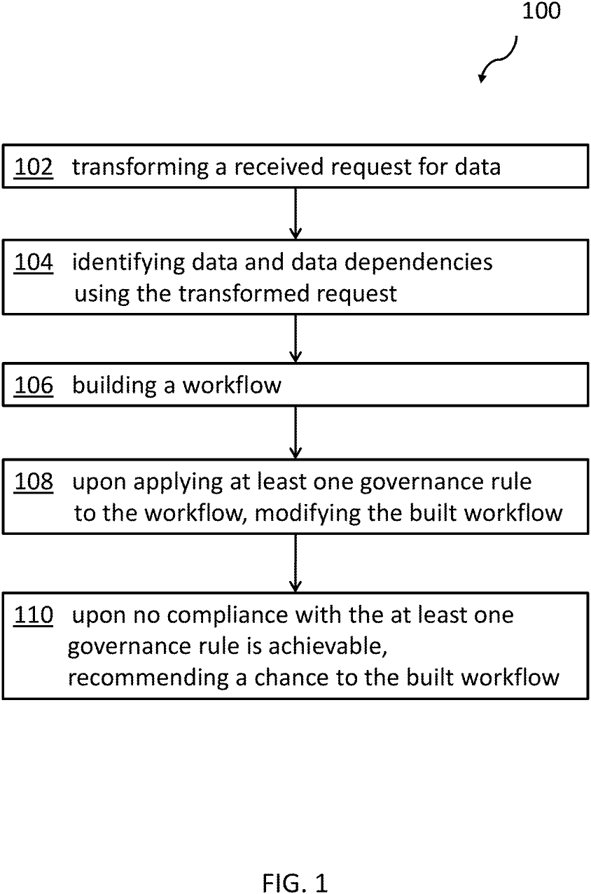

FIG. 1 shows a block diagram of an example embodiment of a computer-implemented method 100 for generating an automated data movement workflow. The method 100 includes the performance of operation 102 wherein a received request for data is transformed. More specifically, the received request for data may be received in a restricted natural language form and may be transformed at operation 102 into a form suitable for accessing a metadata repository. In accordance with at least one embodiment of the present disclosure, the input may be received from a smart data movement interface (for example, a smart data movement advisor and designer); and the input may be driven by technical questions regarding technical parameter values measured (for example, from a production, logistics, quality, or test department of an enterprise) or a mixture of technical and business related questions. A system may be suited to solve data movement tasks for completely business-process-oriented questions.

The method 100 further includes the performance of operation 104, wherein data and data dependencies using the transformed request for data are identified. The method 100 further includes the performance of operation 106, wherein a workflow is built using the identified data and data dependencies. Accordingly, the workflow may be defined by a set of steps of accessing, transforming, and presenting data. In accordance with at least one embodiment of the present disclosure, the performance of operation 106, as well as some others of the workflow generation, may be supported by artificial intelligence techniques.

Additionally, the method 100 further includes the performance of operation 108, wherein the built workflow is modified based on applying at least one governance rule to the workflow. In other words, in the performance of operation 108, upon applying at least one governance rule (for example, compliance words) to the workflow, the built workflow is modified to be compliant with the at least one governance rule. In accordance with at least one embodiment of the present disclosure, if no compliance with the at least one governance rule is achievable, the method 100 further includes the performance of operation 110, wherein a change to the built workflow is recommended. Accordingly, the request identifier value may represent an end-user of the data discovery.

In accordance with at least one embodiment of the present disclosure, a recommended change to the built workflow can include, for example, a recommendation to perform a series of different actions which can include, without limitation, a clearance level for a requestor identifier value, masking or dropping a column from the selection, changing a location of the target data, building an aggregation, and similar actions.

In accordance with at least one embodiment of the present disclosure, the method 100 may also ensure that the identified data are brought into the broader context of clearance levels of the requestor. Additionally, it is generally understood that in practical implementations, compliance is not only tested against a single governance rule but a complete set of governance and compliance rules which may have to be met in combination. For example, if both GDPR (the European Union general data privacy regulation) and PCI (payment card industry) rules are required to be met, but one of them is violated, then the workflow will be considered invalid.

FIG. 2 shows a block diagram of an example embodiment of an ETL pipeline 200 (for example, in a cloud environment). The ETL pipeline 200 starts with a source data 202 from which the requested data are extracted, such as at operation 204. Typically, the data is also transformed, such as at operation 206, into a format for later use. Then the data is loaded, such as at operation 208, into a target data storage 210. In classical analytical applications, structured online transaction processing (OLTP) data are often transformed into online analytical processing (OLAP) data (for example, in multi-dimensional data cubes) for easy and fast analysis. In traditional computing environments, the source data 202 may come from within one company although they may be extracted from different data sources relating to different applications (for example, ERP/enterprise resource processing, CRM/customer relationship management, SCM/supply chain management, etc.). One of the problems with currently available transactional/analytical computing environments lies in the fact that the source data 202 are much more widely spread across different enterprise locations, hybrid data locations (partially within the enterprise and on local cloud storage systems), and on cloud storage systems of different cloud computing providers. This has made the ETL process more complex.

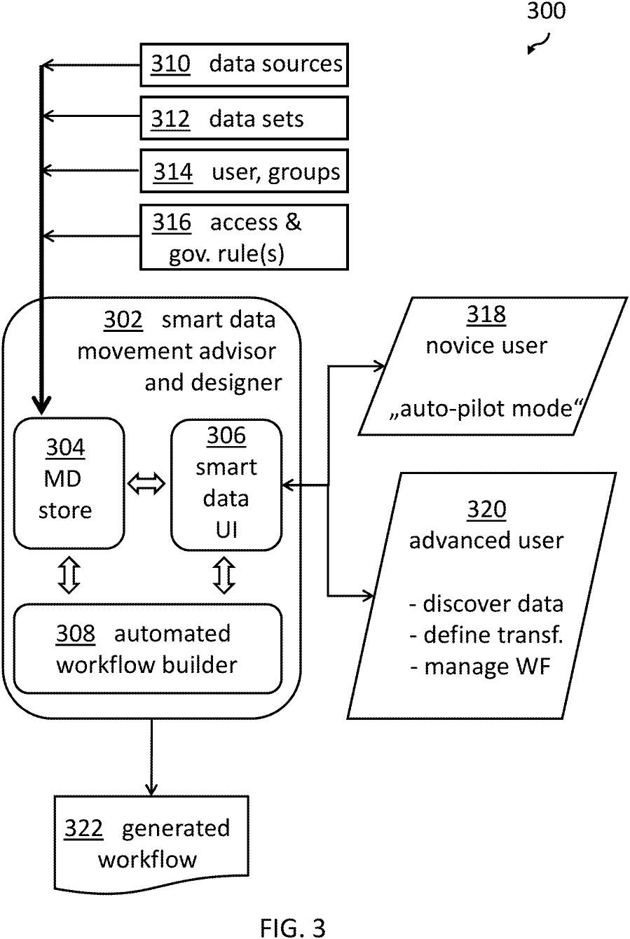

FIG. 3 shows a block diagram of an example embodiment 300 of a smart data movement advisor and designer 302. The smart data movement advisor and designer 302 includes at least three main components which are enabled to constantly exchange data among them: the metadata store 304, the smart data movement user interface (UI) 306 and the automated workflow builder 308. The metadata store 304 may have data about the data stored in the different data stores 310 and the availability of different data sets 312 in different storage locations. Furthermore, the metadata store 304 may have information about users and groups 314, as well as access rights (for example, clearance levels) and governance rules 316.

The smart data user interface 306 may receive requests for data from a novice or inexperienced user 318 or from an advanced user 320 who may have a general understanding about the data sources 310 and dependencies to other data and interdependencies between them.

The smart data UI 306 for the novice user 318 may provide a sort of “auto-pilot mode” which may hide the complexity of building the automated ETL workflow to a greater or lesser degree. An inexperienced user may only enter his inquiry for data in technical or business terms when searching technical (for example, manufacturing/production machine generated data) or business related data or a mixture thereof. Such a user may enter the query or inquiry in a restricted natural language form. Hence, it is not required that the inexperienced user 318 has a clear understanding of formerly structured queries, like SQL (structured query language).

Alternatively, the advanced user 320 may have the option to switch to another mode of the smart data UI 306 in order to enable a more detailed data discovery (for example, in the form of a search interface), thereby allowing the user to define or change existing transformation rules and to manage the workflows (for example, find the resources required or select specific rules for the transformation of the data within the workflow). For both the novice user 318 and the advanced user 320, the automated workflow builder 308 builds the generated workflow 322.

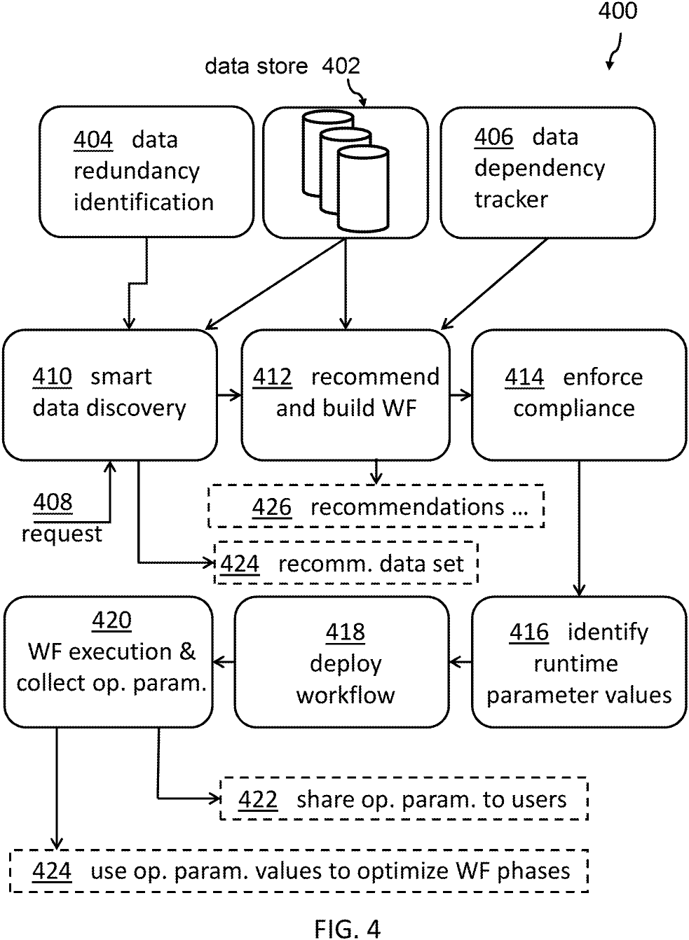

FIG. 4 shows a block diagram of a flow 400 of an embodiment of a smart data movement system. The flow starts with a request 408 for data received by the smart data discovery component 410. In accordance with at least one embodiment of the present disclosure, the smart data discovery component 410 may be substantially similar to the smart data user interface 306, shown in FIG. 3. The smart data discovery component 410 is enabled to identify data sets from the data requirement of data of the user, wherein the smart data discovery component 410 uses the data redundancy identification module 404 in order to analyze the required transformation logic and identify redundancies. The smart data discovery component 410 also accesses the data store 402. In accordance with at least one embodiment of the present disclosure, the data store 402 may be substantially similar to the source data 202, shown in FIG. 2. In accordance with at least one embodiment of the present disclosure, the data store 402 may also include the metadata repository of the metadata store, such as is discussed above in the context of FIG. 3.

Next, the smart data discovery component 410 formats and/or forwards the topmost data sets of the discovered data to the recommend and build workflows component 412. This component 412 is also configured to exchange data with the data store 402 as well as with a data dependency tracker 406 to identify dependencies based on data sets and related transformation logic.

In accordance with at least one embodiment of the present disclosure, the smart data discovery component 410 as well as the recommend and build workflow component 412 generate additional output for the advanced user. In particular, this can include a recommendation 424 to use recommended data sets as well as other recommendations 426, for example, to select recommended algorithms for the transformation, to select recommended implementation details for the workflow, and to select recommended technology to be used. A recommendation for a definition of the workflow, the expected resource consumption, and compliance words to be reflected may also be recommended.

In a next phase, the flow 400 continues with an enforce compliance component 414, which reflects user access rights and governance rules which may be user and location dependent. Subsequently, an identify runtime parameter values component 416 (for example, in an “auto-pilot mode”) determines technical parameter values under which the workflow should be executed. Such values may indicate, for example, a number of computing nodes, a number of CPUs, an amount of memory, involved storage systems, and selected parallelism. These values may also be output as recommendations to the advanced user software that may enable the advanced user to change these variables in order to optimize the transformation and thus, the complete workflow to be executed later on.

The deployment of the workflow is controlled by the deploy workflow component 418, and the workflow execution and collect operational parameter values component 420 monitors the execution of the built workflow and may generate statistical data about the execution. Such data may also be shared, as indicated by reference numeral 422, with the advanced user in order to enable the advanced user to optimize workflow phases as indicated by reference numeral 424. Additionally, the results generated by the component 420 may be used for a continuous learning effect by being fed back to the recommend and build workflow component 412, the enforce compliance component 414, and the identify runtime parameter values component 416. This may be organized in a completely transparent manner for the inexperienced user but may also be fine-tuned and controlled by the advanced user.

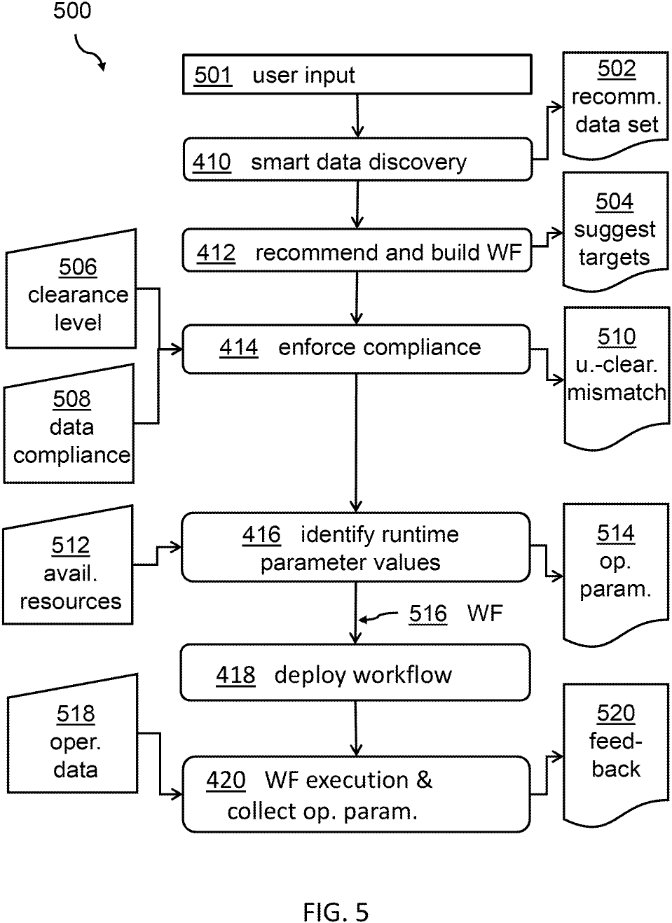

FIG. 5 shows a block diagram of a sample smart data movement flow/workflow/process 500. This flow/workflow is not to be intermixed with the ETL workflow to be built or generated. However, it is a workflow in the context of the components of FIG. 4, focusing more on input and output data.

The flow 500 starts with a user input 501. In accordance with at least one embodiment of the present disclosure, the user input 501 may be substantially similar to the request 408 shown in FIG. 4. A smart data discovery 410 (or the related component) receives the user input 501 and outputs a recommended data set or data sets 502. Next, a workflow for the ETL process is recommended and built at an operation performed by the recommend and build workflow component 412 (also shown in FIG. 4). The output of this operation includes a suggested possible target location 504 for the data after the ETL workflow. Subsequently, an enforcement of available compliance and governance rules is performed at an operation performed by the enforce compliance component 414 (also shown in FIG. 4). For the performance of this operation, user level clearance data 506 and data compliance details 508 are used as input to the enforce compliance component 414.

One potential output of the enforce compliance component 414 from the performance of the above operation can be a user clearance mismatch 510. For example, a user having requested certain data may not have the clearance level, and therefore does not have access rights to the selected data. Optionally, the system may propose elevating the clearance level for the user requesting the data. An example of this is discussed in further detail below. Following the performance of this operation by the enforce compliance component 414, all relevant data are known: the identified data sets, already collected data statistics, the transformation details, a replica detail of data to be accessed, as well as the target location for the data after the ETL workflow.

In a next phase or process, at an operation performed by the identify runtime parameter values component 416 (also shown in FIG. 4), runtime parameter values for the execution of the workflow are determined. More specifically, data about available resources 512 can be utilized in the performance of the operation by the identify runtime parameter values component 416, and operational parameter values 514 can be output by the identify runtime parameter values component 416. The performance of the operation by the identify runtime parameter values component 416 relies partially on available statistics of earlier workflow generations, data replication details, and transformation parameter values, like already available jointed tables, and decisions, like whether to use semi join operations or not.

Following the performance of this operation by the identify runtime parameter values component 416, an ETL workflow 516 is fixed and can be deployed at an operation performed by the deploy workflow component 418 (also shown in FIG. 4). Finally, at an operation performed by the workflow execution and collect operational parameter values component 420 (also shown in FIG. 4), workflow events execution and collection of operational parameter values collects operational data 518 and triggers feedback operations 520 into earlier process phases.

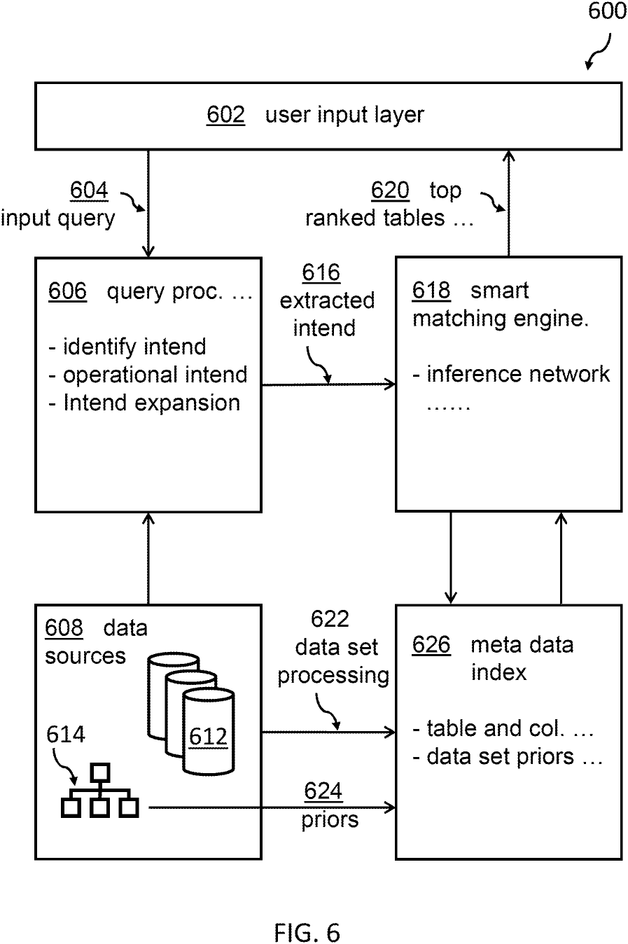

FIG. 6 shows an example embodiment of a technical architecture 600 of the smart data discovery system for generating workflows. At least in parts, components discussed in earlier figures may be described here with a different reference numeral. A core component of the architecture 600 is the user interface layer 602. From the user interface layer 602, an input query 604 is forwarded to the query processor and intent identification unit 606 which is configured to identify user intentions (based on the constraint natural language), transform those to an operational intent, and expand the operational intent into machine interpretable commands.

Based on this, extracted intents 616 are forwarded to a smart matching engine 618. In accordance with at least one embodiment of the present disclosure, the smart matching engine 618 can include an inference network (for example, a neural network) used to combine evidence from multiple sources. For this, access is made to a metadata index 626, to access table and column metadata as well as data set priors (such as version, page rank, etc.). At operation 620, top ranking tables are provided back to the user interface layer 602.

Alternatively, the query processor and intent identification unit 606 accesses data sources 608 including the data sets 612 as well as one or more business concept ontologies, for example, in which organizational dependencies 614 and thus also data dependencies can be defined. These data are finally accessed by the smart matching engine 618 via the metadata index 626. This is indicated by the data set processing 622 and priors 624 errors.

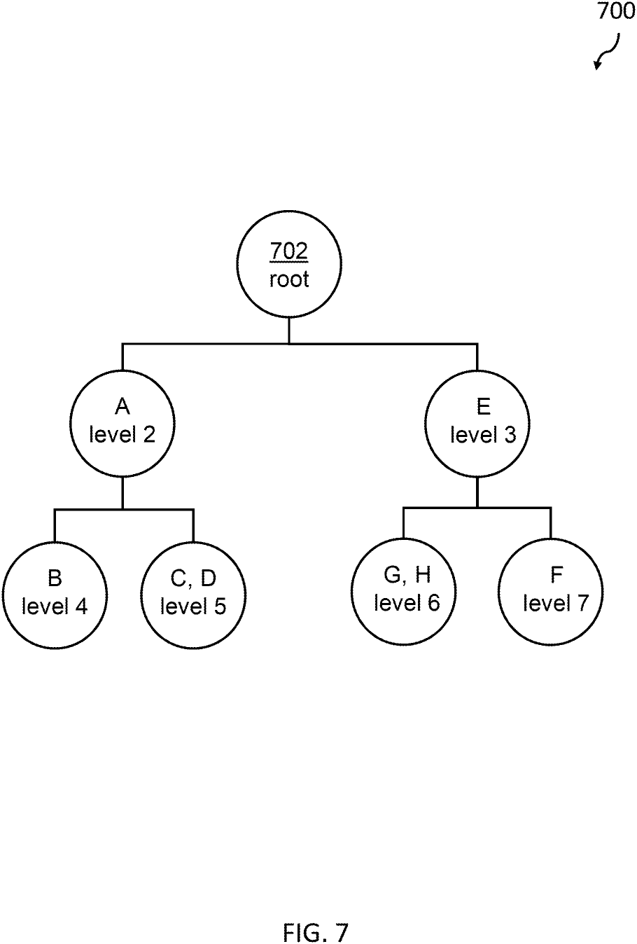

FIG. 7 shows an example embodiment of a clearance level tree 700 with a root node 702 for data access rights. For this, a simple example may be illustrative. A user may have a clearance level of 2, meaning that he is allowed to access data from the locations A, B, C, D. The dependencies of the clearance level tree 700 are shown in the hierarchical diagram. If the same user wants to access data that are replicated at locations C and F, having access to data at locations C is not a problem because these data fall under his clearance level. However, it could be that an execution using the data at location F may be faster. In this example, the user may have an elevated clearance level in order to access data with clearance level 7. The assumption that the workflow would be executed faster may be based on an assumption, for example, that the bandwidth available at location F is higher.

At this point, it may also be useful to discuss workflow binding. A data set refresh or update can be linked to refresh events, for example, to update all upstream data sets in one of the upstream data sets or only in certain upstream data sets. Accordingly, it is a source-driven data refresh cycle approach. For this, schedules/refresh events may be extracted, for example, from an already existing data store workflow scheduler also using operational metadata and/or a CPD orchestration engine (for example, IBM product Cloud Pack for Data). This way, the binding can be expressed as “we freshen any of the sources” by default.

The following customer/sales example may be illustrative. A refresh of deals and/or a refresh of customers may lead to a refresh of revenue data. A refresh of opportunity data as well as a refresh of the customer data may lead to a refresh of propensity data. Both the refresh of the revenue data and the refresh of the propensity data may trigger a refresh of recommendations for salespeople or, in a reverse scenario, a recommendation what to buy by customers (for example, in an online shop scenario).

Furthermore, notably, the smart data movement detects data redundancy and optimizes its reuse. An illustrative example is provided. The statement select * from A a, B b where a.item_id = b.item_id may have been executed as part of the ETL workflow at an earlier time. In a subsequent data request, the following statement may be generated from the constraint natural language input: select a.* from A a join B b on a.item_id = b.item_id. Basically, this would reside in the same data set AB as the query mentioned above. Hence, the result would be the same. The smart data movement, in particular the redundancy identification component, is able to detect such redundancies and reuse the already generated data set without generating an additional unnecessary workflow. This may become possible through a platform-wide data set registry (data catalog). This may enable the removal of duplicated data (for example, data sets with the same definition), and it may also allow for requests (for example, workflow definitions that already exist) for data sets with similar definitions to be optimized. This may allow a lower resource usage.

According to another aspect of the present disclosure, a recommender and generator system for generating an automated data movement workflow may be provided. The system may comprise a processor and a memory, communicatively coupled to the processor, wherein the memory stores program code portions that, when executed, enable the processor, to transform a received request for data, which was received in a restricted natural language form, into a form suitable for accessing a metadata repository, to identify data and data dependencies using the transformed request for data in the form suitable for accessing a metadata repository, and to build a workflow using the identified data and data dependencies.

Furthermore, the recommender and generator system may also comprise upon applying at least one governance rule to the workflow, modify the built workflow to be compliant with the at least one governance rule, and if no compliance with the at least one governance rule is achievable, recommend a change to the built workflow.

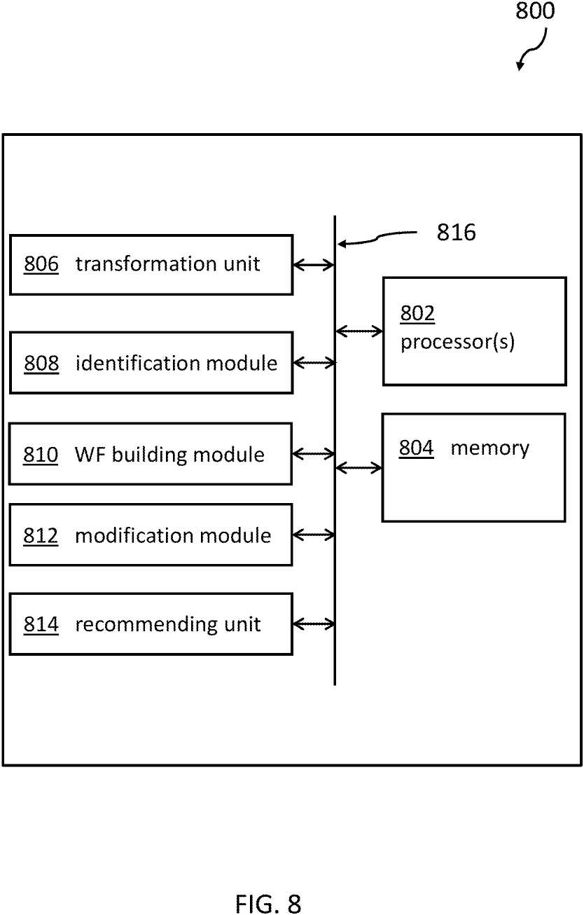

FIG. 8 shows a block diagram of a recommender and generator system 800 for generating an automated data movement workflow. The system comprises a processor 802 and a memory 804 communicatively coupled to the processor 802. The memory 804 is configured to store sections of program code portions which, when executed, enable the processor 802, to transform a received request for data, such as that received by a transformation unit 806, received in a restricted natural language form, into a form suitable for access to a metadata repository.

The processor 802 of the system 800 is further configured to identify data and data dependencies, for example through an identification module 808, using the request for data that has been transformed into the form suitable for accessing a metadata repository. The processor 802 is further configured to build a workflow, for example through a workflow (WF) building module 810, using the identified data and data dependencies.

Upon applying at least one governance rule to the workflow, the processor 802 is also configured to modify the built workflow, for example by a modification module 812, to be compliant with the at least one governance rule. The processor 802 is further configured to recommend a change to the built workflow if no compliance with the at least one governance rule is achievable. In accordance with at least one embodiment of the present disclosure, this may be enabled by the recommending unit 814.

In accordance with at least one embodiment of the present disclosure, all functional units, modules, and functional blocks (such as the processor 802, the memory 804, the transformation unit 806, the identification module 808, the workflow building module 810, the modification module 812 and the recommending unit 814) of the system 800 may be communicatively coupled to each other for signal or message exchange in a selected 1:1 manner. Alternatively, the functional units, modules, and functional blocks of the system 800 can be linked to a system internal bus system 816 for a selective signal or message exchange.

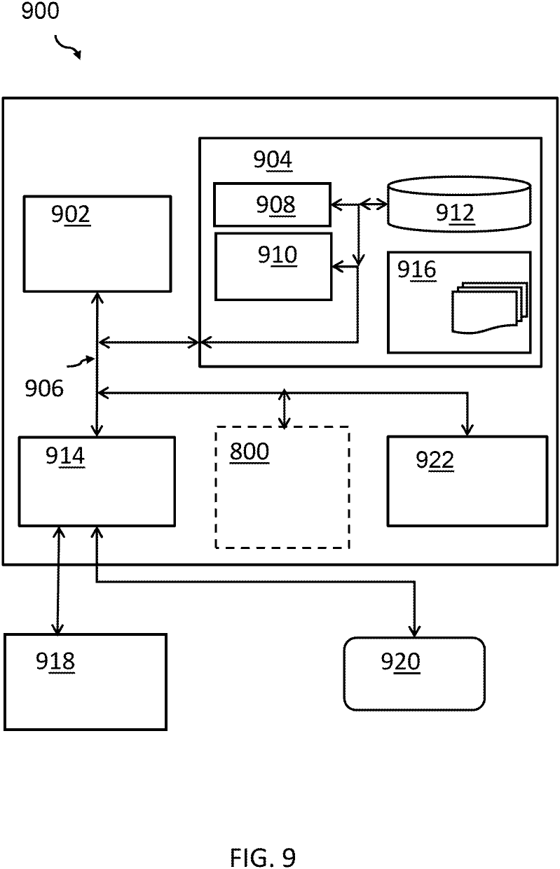

Embodiments of the present disclosure may be implemented together with virtually any type of computer, regardless of the platform being suitable for storing and/or executing program code. FIG. 9 shows, as an example, a computing system 900 suitable for executing program code related to the proposed method.

The computing system 900 is only one example of a suitable computer system and is not intended to suggest any limitation as to the scope of use or functionality of embodiments of the disclosure described herein, regardless of whether the computer system 900 is capable of being implemented and/or performing any of the functionality set forth hereinabove. In the computer system 900, there are components, which are operational with numerous other general purpose or special purpose computing system environments or configurations. Examples of well-known computing systems, environments, and/or configurations that may be suitable for use with computer system/server 900 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 900 may be described in the general context of computer system-executable instructions, such as program modules, being executed by a computer system 900. Generally, program modules may include routines, programs, objects, components, logic, data structures, and so on that perform particular tasks or implement particular abstract data types. Computer system/server 900 may be practiced in distributed cloud computing environments where tasks are performed by remote processing devices that are linked through a communications network. In a distributed cloud computing environment, program modules may be located in both, local and remote computer system storage media, including memory storage devices.

As shown in the figure, computer system/server 900 is shown in the form of a general-purpose computing device. The components of computer system/server 900 may include, but are not limited to, one or more processors or processing units 902, a system memory 904, and a bus 906 that couple various system components including system memory 904 to the processor 902. Bus 906 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 900 typically includes a variety of computer system readable media. Such media may be any available media that is accessible by computer system/server 900, and it includes both, volatile and non-volatile media, removable and non-removable media.

The system memory 904 may include computer system readable media in the form of volatile memory, such as random access memory (RAM) 908 and/or cache memory 910. Computer system/server 900 may further include other removable/non-removable, volatile/non-volatile computer system storage media. By way of example only, a storage system 912 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 906 by one or more data media interfaces. As will be further depicted and described below, memory 904 may include at least one program product having a set (e.g., at least one) of program modules that are configured to carry out the functions of embodiments of the disclosure.

The program/utility, having a set (at least one) of program modules 916, may be stored in memory 904 by way of example, and not limiting, as well as an operating system, one or more application programs, other program modules, and program data. Each of the operating systems, one or more application programs, other program modules, and program data or some combination thereof, may include an implementation of a networking environment. Program modules 916 generally carry out the functions and/or methodologies of embodiments of the disclosure, as described herein.

The computer system/server 900 may also communicate with one or more external devices 918 such as a keyboard, a pointing device, a display 920, etc.; one or more devices that enable a user to interact with computer system/server 900; and/or any devices (e.g., network card, modem, etc.) that enable computer system/server 900 to communicate with one or more other computing devices. Such communication can occur via Input/Output (I/O) interfaces 914. Still yet, computer system/server 900 may communicate with one or more networks such as a local area network (LAN), a general wide area network (WAN), and/or a public network (e.g., the Internet) via network adapter 922. As depicted, network adapter 922 may communicate with the other components of the computer system/server 900 via bus 906. It should be understood that, although not shown, other hardware and/or software components could be used in conjunction with computer system/server 900. Examples, include, but are not limited to: microcode, device drivers, redundant processing units, external disk drive arrays, RAID systems, tape drives, and data archival storage systems, etc.

Additionally, the recommender and generator system 800 (shown in FIG. 8) for generating an automated data movement workflow may be attached to the bus system 906.

The descriptions of the various embodiments of the present disclosure have been presented for purposes of illustration and are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to limit the disclosure. As used herein, the singular forms a, an, and the are intended to include the plural forms as well, unless the context clearly indicates otherwise. It will further be understood that the terms comprises and/or comprising, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description but is not intended to be exhaustive or limited to the disclosure in the form disclosed. Many modifications and variations will be apparent to those of ordinary skills in the art without departing from the scope and spirit of the disclosure. The embodiments are chosen and described in order to best explain the principles of the disclosure and the practical application, and to enable others of ordinary skills in the art to understand the disclosure for various embodiments with various modifications, as are suited to the particular use contemplated.

What is claimed is:

1. A computer-implemented method for generating an automated data movement workflow, the method comprising:
transforming a received request for data, which was received in a restricted natural language form, into a form suitable for accessing a metadata repository;
identifying data and data dependencies using the transformed request for data;
building a workflow using the identified data and data dependencies; and
upon applying at least one governance rule to the workflow, modifying the built workflow to be compliant with the at least one governance rule, and if no compliance with the at least one governance rule is achievable, recommending a change to the built workflow.

2. The method according to claim 1, wherein building the workflow includes selecting at least one from the group consisting of a data transformation method, an implementation technique, and used infrastructure.

3. The method according to claim 1, further comprising:
selecting runtime parameter values for executing the built workflow.

4. The method according to claim 3, further comprising:
modifying, based on input received via a user interface, the selecting runtime parameter values using the user interface.

5. The method according to claim 1, further comprising:
modifying the identified data and data dependencies before executing the built workflow by receiving a respective instruction using a user interface.

6. The method according to claim 1, further comprising:
modifying the built workflow before executing the built workflow by receiving a respective instruction using a user interface.

7. The method according to claim 6, further comprising:
determining at least one of an expected resource consumption value or a potential violation of a governance rule.

8. The method according to claim 1, further comprising:
collecting and storing execution data during an execution of the workflow.

9. The method according to claim 8, further comprising:
upon receiving a comparable request for data if compared to stored received request for data, using the collected execution data of the workflow retrieving a stored built workflow.

10. The method according to claim 1, further comprising:
using the collected and stored execution data for an optimization of a subsequent comparable workflow to be built under a constraint that a value of a function is minimized, wherein the function has a target resource consumption and a response time of the built workflow as variables.

11. The method according to claim 1, wherein the request in the restricted natural language form includes at least a term for a data source and a term for a data transformation.

12. A recommender and generator system for generating an automated data movement workflow, the system comprising:
a processor; and
a memory, communicatively coupled to the processor, wherein the memory stores program code portions that, when executed, enable the processor to perform a method, the method comprising:
transforming a received request for data, which was received in a restricted natural language form, into a form suitable for accessing a metadata repository,
identifying data and data dependencies using the transformed request for data,
building a workflow using the identified data and data dependencies, and
upon applying at least one governance rule to the workflow, modifying the built workflow to be compliant with the at least one governance rule, and if no compliance with the at least one governance rule is achievable, recommending a change to the built workflow.

13. The recommender and generator system according to claim 12, wherein the method further includes selecting at least one selected from a group consisting of a data transformation method, an implementation technique, and used infrastructure.

14. The recommender and generator system according to claim 12, wherein the method further includes selecting runtime parameter values for executing the built workflow.

15. The recommender and generator system according to claim 14, wherein the method further includes at least one operation selected from the group consisting of of:
modifying, based on input received via a user interface, the selecting runtime parameter values using the user interface,
modifying the identified data and data dependencies before executing it by receiving a respective instruction using a user interface, and
modifying the built workflow before executing it by receiving a respective instruction using a user interface.

16. The recommender and generator system according to claim 15, wherein the method further includes determining an expected resource consumption value and/or potential violation of a governance rule.

17. The recommender and generator system according to claim 14, wherein the method further includes collecting and storing execution data during an execution of the workflow.

18. The recommender and generator system according to claim 17, wherein the method further includes:
if receiving a comparable request for data in comparison to stored received request for data, using the collected execution data of the workflow retrieving a stored built workflow.

19. The recommender and generator system according to claim 12, wherein the method further includes using the collected and stored execution data for an optimization of a subsequent comparable workflow to be built under the constraint that a function value is minimized, wherein the function has a target resource consumption and a response time of the built workflow as variables.

20. A computer program product for generating an automated data movement workflow, the computer program product comprising a computer readable storage medium having program instructions embodied therewith, the program instructions being executable by one or more computing systems or controllers to cause the one or more computing systems to perform a method, the method comprising:
transforming a received request for data, which was received in a restricted natural language form, into a form suitable for accessing a metadata repository;
identifying data and data dependencies using the transformed request for data;
building a workflow using the identified data and data dependencies; and
upon applying at least one governance rule to the workflow, modifying the built workflow to be compliant with the at least one governance rule, and if no compliance with the at least one governance rule is achievable, recommending a change to the built workflow.
